(19) United States
(12) Patent Application Publication
(10) Pub. No.: US 2006/0003147 A1
(43) Pub. Date: Jan. 5, 2006

(54) Raised fabric having three-dimensional pattern

(75) Inventors: Harukazu Kubota, Fukui-shi (JP); Takahiro Kosaka, Fukui-shi (JP)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Seiren Co., Ltd.

(21) Appl. No.: 11/173,527

(22) Filed: Jul. 1, 2005

(30) Foreign Application Priority Data
Jul. 1, 2004 (JP) 2004-195596

(51) Int. Cl. B32B 3/00

(52) U.S. Cl. 428/156

(57) ABSTRACT

The present invention provides a raised fabric having a three-dimensional pattern, of which an uneven pattern formed on the surface of the raised fabric shades when viewed from any direction, and which is suitable as an interior material that can enhance the appearance of the interior of cars and houses having a more three-dimensional design. That is, the present invention relates to a raised fabric having a three-dimensional pattern, of which the cross sectional areas in plurality of cross sections parallel to each other are different from each other.

### BACKGROUND OF THE INVENTION

The present invention relates to a raised fabric having a three-dimensional pattern, and in particular, to a raised fabric where a shaded three-dimensional pattern is formed on the surface of the raised fabric, and which is utilized as an interior material that can enhance the appearance of the interior of a car or house. Furthermore, the present invention relates to a raised fabric having a three-dimensional pattern which has plurality of types of unevenness on the surface of the raised fabric.

In recent years, the demand for fabrics having three-dimensional patterns on the surface have increased in the field of interior materials for cars and houses, because they can provide good design and a sense of high class.

An uneven pattern where a pattern is formed of lines approximately perpendicular to the fabric surface in a cross section has conventionally been formed on the raised fabric by means of an emboss process or a welder process. In addition, an uneven pattern where the pattern forms a striated V shape in the cross section exists, as that shown in JP-A-10-298863.

In the case where an uneven pattern is formed of lines approximately perpendicular to the surface of the fabric in a cross section, or in the case where an uneven pattern is formed of lines in a cross section according to the prior art, the design tends to become uniform, and the appearance from all direction are not enhanced when the fabric is utilized for the interior of a car or house, though the appearance from a particular direction is enhanced.

### SUMMARY OF THE INVENTION

An object of the present invention is to provide a raised fabric having a three-dimensional pattern, of which an uneven pattern formed on the surface of the raised fabric shades when viewed from any direction, and which is suitable as an interior material that can enhance the appearance of the interior of cars and houses having a more three-dimensional design.

That is to say, the present invention relates to a raised fabric having a three-dimensional pattern, of which the cross sectional areas in plurality of cross sections parallel to each other are different from each other.

Furthermore, it is preferable that the cross sectional forms in plurality of cross sections parallel to each other are also different from each other.

It is preferable that the upper sides of the cross sections are formed of continuous curves having curvature radii of 1 mm to 10 mm.

It is preferable that the upper sides of the cross sections are formed of continuous curves having different curvature radii.

It is preferable that the upper sides of the cross sections are formed of continuous lines having angles from 20° to 90° relative to the bottom of the cross sections.

It is preferable that the upper sides of the cross sections are formed of continuous lines having different angles relative to the bottom of the cross sections.

It is preferable that the distances between the cross sections are not greater than 0.5 mm.

It is preferable that the pattern is obtained by discontinuously changing an amount of a fiber decomposing agent that is attached to each microscopic area using an ink jet system.

According to the present invention, an uneven pattern, such as natural stone grain tone, natural wood grain tone or water wave tone, can be expressed on the surface of a raised fabric, and a shade in an uneven pattern is always formed, under any circumstances of use, and therefore, a raised fabric that is appropriate as an interior material that can enhance the appearance of the interior of cars and houses can particularly be provided.

### BRIEF DESCRIPTION OF THE DRAWINGS

FIG. 1 is a diagram showing an example of a microscopic cross section of a raised fabric according to the present invention;

FIG. 2 is a diagram showing curves and lines in the upper side of the cross section of a raised fabric according to the present invention;

FIG. 3 is a schematic cross sectional diagram showing an example of a raised fabric according to the present invention;

FIG. 4 is a schematic cross sectional diagram showing an example of a raised fabric according to the present invention;

FIG. 5 is a schematic cross sectional diagram showing an example of a raised fabric according to the present invention;

FIG. 6 is a schematic cross sectional diagram showing an example of a raised fabric according to the present invention;

FIG. 7 is a photograph showing an image of a ripple;

FIG. 8 is a diagram illustrating digital data of the ripple;

FIG. 9 is a diagram schematically showing the cross section along A-A of a fabric where a three-dimensional pattern is formed according to Example 1;

FIG. 10 is a diagram schematically showing the cross section along B-B of the fabric where a three-dimensional pattern is formed according to Example 1;

FIG. 11 is a diagram illustrating digital data of a willow;

FIG. 12 is a diagram schematically showing the cross section along C-C of a fabric where a three-dimensional pattern is formed according to Example 2;

FIG. 13(a) is a diagram schematically showing a fabric where a three-dimensional pattern is formed according to Comparative Example 1, and FIG. 13(b) is a diagram schematically showing the cross section along D-D; and

FIG. 14(a) is a diagram schematically showing a fabric where a three-dimensional pattern is formed according to Comparative Example 2, and FIG. 14(b) is a diagram schematically showing the cross section along E-E.

### DETAILED DESCRIPTION

A raised fabric having a three-dimensional pattern (hereinafter sometimes simply referred to as raised fabric) according to the present invention can be utilized primarily as a skin material for car seats or sofas or the like in the house. In such a case, there is a variety of forms of seats and sofas, and inevitably, people see the design of the skin material from a variety of angles.

In the case of a car seat, the position of the light source that illuminates the skin material, such as sunbeams, changes all the time, due to the movement of the car or the passage of time, and therefore, people recognize the design of the skin material in a variety of illuminations of light from various directions. Accordingly, the three-dimensional design must be recognizable in the illumination of light from various directions and as viewed from various directions, in order to enhance the appearance of the interior.

The surface of a natural stone, for example, forms a random uneven surface, and it is found that both unevenness with a number of round corners and unevenness with sharp corners exist, when viewed microscopically. Also, in the case of a natural wood grain plate, unevenness in the trench form in the surface has rounded corners. In addition, water waves are formed of a number of sine waves. As shown by these examples, the surfaces with a number of rounded corners and/or the surfaces formed of sharp inclined corners form complex shades because they irregularly reflect parallel light beams of natural light.

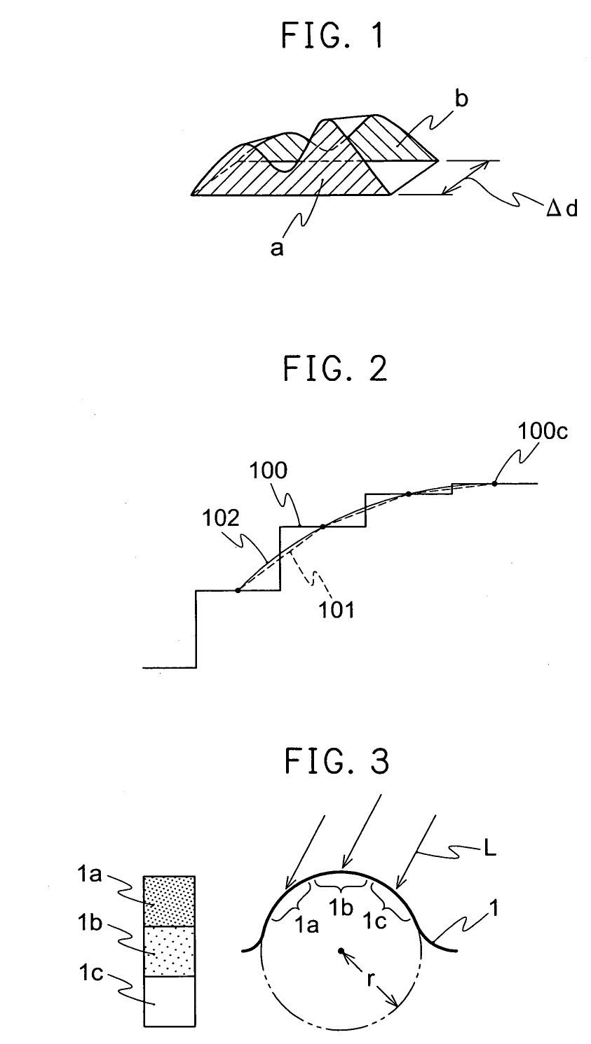

FIG. 1 shows an example of a microscopic cross section of a raised fabric according to the present invention.

An arbitrary microscopic cross section (a) of an uneven pattern formed on the surface of a fabric shows one unit of the pattern where the upper side of the cross section is formed of continuous curves having different curvature radii. Here, as shown in FIG. 2, the curves include a curve 102 that circumscribes a polygonal line 101 that is formed by connecting the center 100c of an upper area formed raised pile having the same height to the center of the adjacent upper area in the case where height of area 100 formed raised pile having the same height changes in step form. The cross section area and form of this cross section (a) are different from those of a microscopic cross section (b) which is separated from cross section (a) by a microscopic distance (Δd) and parallel to cross section (a) when one unit of the pattern of cross section (a) is compared with one unit of the pattern of cross section (b). That is to say, the three-dimensional pattern formed in the raised fabric according to the present invention is characterized in that the cross sectional area and the cross sectional form thereof continuously change. In other words, the three-dimensional pattern formed on the surface of the raised fabric according to the present invention has an uneven pattern that is formed of continuous curved surfaces and inclined surfaces in at least two directions that are perpendicular to each other, for example, in at least the direction of longitudinal threads and in the direction of lateral threads of, for example, a fabric, and therefore, the cross section area and the cross section form continuously change.

Furthermore, the depth of the unevenness of the above described cross section (a) may be different from that of cross section (b). As a result of this, a more complex shade can be created.

In the case where the upper side of the cross section of a fabric is made of continuous curves, it is preferable for the curvature radius r thereof to be in a range from 1 mm to 10 mm. It is more preferable for the range to be from 3 mm to 8 mm.

The curved surface results in shade effects because, as shown in FIG. 3, the brightness of the surface differs depending on the place, due to the differences in the light beams and the angle of the surface in the case where parallel light beams L illuminate the curved surface of upper side 1 of the cross section, and thereby, gradation of brightness is created. Therefore, in the case where curvature radius r is smaller than 1 mm, it is difficult for the surface of the uneven pattern to be formed as a curved surface, making it difficult to create a difference in the shade effect on the surface. In addition, in the case where curvature radius r exceeds 10 mm, the curved surface is recognized almost as a plane on the fabric, and therefore, it tends to be difficult for the shade effect to be obtained on the surface. Here, in the figure, portions of the curved surface are denoted as 1a to 1c, and the brightness thereof is schematically indicated.

Upper side 1 of the above described cross section may be formed of curves having the same curvature radius, or may be made of a combination of curves having different curvature radii. In particular, it is preferable for the upper side to be made of a combination of curves having different curvature radii, considering that this can randomly create gradation of brightness.

In addition, in the case where upper side 1 of the cross section of the fabric is made of continuous lines, it is preferable for the angles of the inclination thereof to be 20° to 90° relative to the bottom 2 of the cross section. It is more preferable for the angles to be from 30° to 90°.

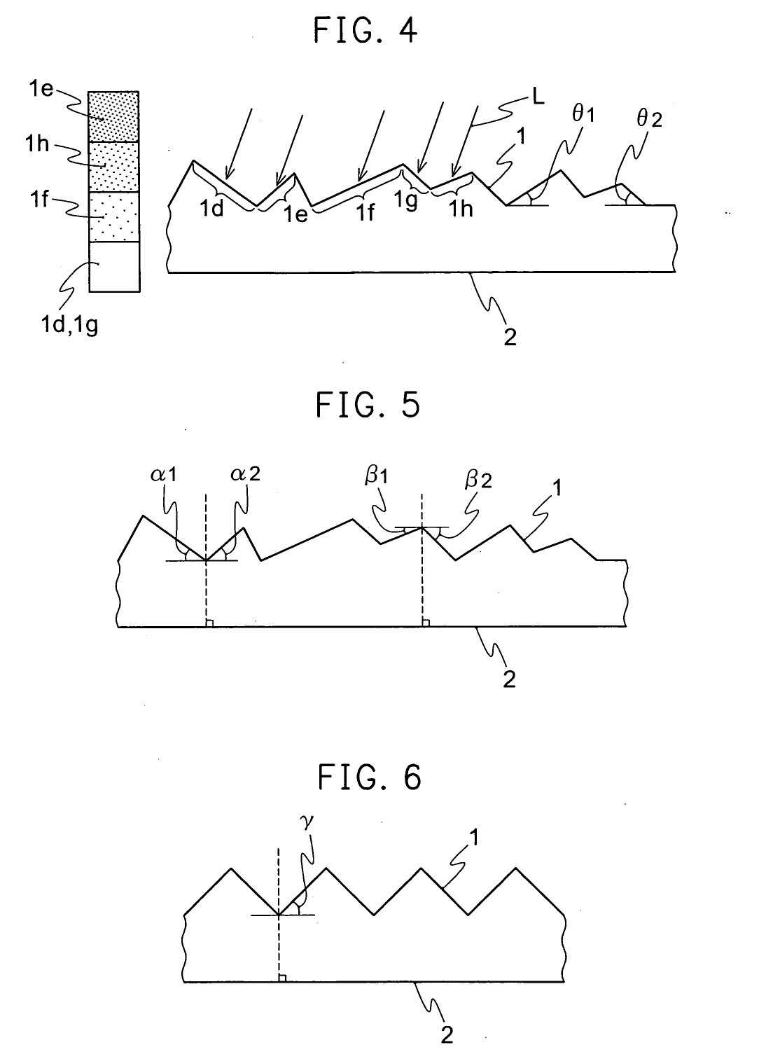

Continuous lines having angles create a shade effect because, as shown in FIG. 4, brightness on the inclined surface differs depending on the angle of the inclined surfaces of upper side 1 of the cross section in the case where they are illuminated by parallel light beams L. In the case where the angle (θ1 or θ2) is smaller than 20°, the inclined surface is recognized almost as a plane on the fabric, and thereof, it tends to be difficult for the shade effect to be obtained. Here, in the figure, portions of the inclined surfaces are denoted as 1d to 1h, and the brightness thereof is schematically indicated.

Upper side 1 of the above described cross section may be formed of lines having the same inclination angles, or may be made of continuous lines having different inclination angles. In particular, it is preferable for the upper side to be made of a combination of lines having different inclination angles, considering that this can create a random shade effect. Here, FIG. 4 shows a case where lines having different inclination angles continue.

Here, as shown in FIG. 2, these lines include line 101 that is formed by connecting center 100c of the upper area formed raised pile having the same height to the center of the adjacent upper area in the case where the height of area formed raised pile having the same height 100 changes in step form.

In addition, upper side 1 of the above described cross section may be made of a combination of curves as described above and lines as described above.

Here, in the case where the upper side of the above described cross section is made of lines having different inclination angles, the inclination angles of the lines forming recesses and/or protrusions on the right side and the left side are not symmetrical, so that the same uneven pattern can express different shades, depending on the incident angle of light or the angle from which it is viewed.

Concretely speaking, as shown in FIG. 5, inclination angles (α1 and α2) on the right side and the left side which are divided by a vertical line that passes through the lowest portion of a recess are different from each other, and/or inclination angles (β1 and β2) on the right side and the left side which are divided by a vertical line that passes through the highest portion of a protrusion are different from each other. It is preferable for the above described inclination angles α1, α2, β1 and β2 to be respectively in a range from 20° to 90°. It is more preferable for the angles to be respectively in a range from 30° to 90°. In the case where an inclination angle is smaller than 20°, the inclined surface is recognized almost as a plane on the textile, and therefore, it tends to be difficult to obtain shade effects.

In addition, as shown in FIG. 6, the upper side 1 of the above described cross section may be made of lines having the same inclination angle γ.

In addition, the cross sectional areas of plurality of cross sections which are parallel to each other may be different from each other when an arbitrary width is selected from among one pattern of the design, and it is preferable for the cross sectional areas to be different from each other when cross sections are selected in a manner where the distance (Δd) between the cross sections is not greater than 0.5 mm. More preferably, the distance between the cross sections is not greater than 0.3 mm. In addition, it is preferable for the distance to be not less than 0.1 mm.

In the case where the cross sectional areas and/or cross sectional forms change only when the distance between the cross sections is greater than 0.5 mm, smooth curves and inclined lines cannot be formed on the upper side of these cross sections, and only a change in step form can be obtained. Accordingly, in order for these arbitrary cross sections and other cross sections at a distance from these cross sections and parallel to these cross sections to have continuously changing cross sectional areas and/or cross sectional forms, it is preferable for the cross sectional areas and/or cross sectional forms to be different from each other when the cross sections between which the distance is not greater than 0.5 mm are compared.

The cross sections having the above described relationships are connected, and thereby, uneven patterns that exist in the natural world, such as natural stone grain tone, natural wood grain tone and water wave tone, can be expressed on the surface of a textile with continuous curves and inclined surfaces of a variety of sizes, and thus, the appearance of the fabric as an interior material is further enhanced, due to a complex shade effect.

Uneven patterns formed on the surface of a textile are not particularly limited, but rather, may be any uneven pattern that exists in the natural world, or any artificial geometric pattern. According to the present invention, curved and inclined surfaces of which the cross sectional areas and cross sectional forms change continuously are combined. Therefore, even if artificial geometric patterns is formed, a large shade effect is obtained in comparison with uneven patterns formed in a conventional emboss process or welder process, or monotonous uneven patterns made of lines, and particularly, the appearance of a fabric as an interior material can be enhanced.

A raised fabric according to the present invention is formed by adding a fiber decomposing agent to a fabric using a conventionally carried out printing system, such as screen printing, rotary screen printing or ink jet printing. In particular, an ink jet system is preferable, considering that the amount of fiber decomposing agent that is added to each microscopic area can be controlled.

Weak acid guanidine salts, phenols, alcohols, alkaline metal hydroxides, alkali-earth metal hydroxides and the like can be cited for the above described fiber decomposing agent. In particular, weak acid guanidine salts are preferable, considering that they allow a large unevenness effect to be obtained, and are excellent in terms of environment and safety.

In addition, it is preferable for the amount of fiber decomposing agent that is added to be in a range from 1 g/m² to 50 g/m², and it is more preferable for the amount to be in a range from 10 g/m² to 30 g/m². In the case where the added amount is less than 1 g/m², a sufficient unevenness effect tends not to be obtained, and conversely, in the case where the amount exceeds 50 g/m², the fiber decomposing effect often becomes too strong, and piles of the raised fabric tends to disappear.

Here, in the case where the above described fiber decomposing agent is added by means of an ink jet system, it is preferable to dissolve the fiber decomposing agent in water, considering that this allows stable discharge for a long period of time.

In this case, it is preferable for the concentration of the fiber decomposing agent to be in a range from 10 wt % to 35 wt %, and it is more preferable for the concentration to be in a range from 15 wt % to 30 wt %. In the case where the concentration is lower than 10 wt %, a sufficient unevenness effect tends not to be obtained, and conversely, in the case where the concentration exceeds 35 wt %, the amount of fiber decomposing agent that is dissolved in water becomes close to its limit, causing nozzle clogging when deposition occurs, and it tends to become impossible to maintain stable discharge for a long period of time.

In addition, it is preferable for the viscosity of the ink in the case where the ink is added by means of an ink jet system to be in a range from 1 cps to 10 cps at 25° C., and it is more preferable for the viscosity to be in a range from 1 cps to 5 cps. In the case of less than 1 cps, the discharged ink droplets tend to burst in the air, deteriorating the sharpness of the uneven pattern, while in the case of more than 10 cps, discharge of ink from the nozzle tends to become difficult, due to high viscosity.

In the case where a fiber decomposing agent is used by dissolving it in water, it is preferable to make it contain urea, in order to stably dissolve it in water. Urea is optimal because it slightly affects viscosity and surface tension, which are important factors for the ink for an ink jet. It is preferable for the content urea to be in a range from 0.1 wt % to 10 wt %, and it is more preferable for the content to be in a range from 0.5 wt % to 5 wt %. In the case where the content of urea is lower than 0.1 wt %, it does not have sufficient effect as a solubilizer, and thus, it tends to cause nozzle clogging, while in the case where the content exceeds 10 wt %, uneven patterning of a fabric, which is the original object of the invention, tends to become insufficient.

Furthermore, it is desirable to make at least one type selected from a group consisting of polyalcohol, polyalcohol derivatives and surfactants to which ethylene oxide has been added be contained, considering that air clogging of the nozzle can be prevented by using such an ink. It is preferable for the content thereof to be in a range from 0.1 wt % to 10 wt %, and it is more preferable for the content to be in a range from 0.5 wt % to 5 wt %. In the case where the content is lower than 0.1 wt %, the effect of preventing air clogging of the nozzle becomes low, and an ink that easily causes air clogging tends to be obtained, while in the case where the content exceeds 10 wt %, the ink has a high viscosity, and discharge from the nozzle tends to become difficult.

Glycerin, diethylene glycol, diethylene glycol monomethyl ether, diethylene glycol monobutyl ether, triethylene glycol, triethylene glycol dimethyl ether, triethylene glycol monomethyl ether, propylene glycol, propylene glycol monomethyl ether, dipropylene glycol, tripropylene glycol, trimethylene glycol, polyethylene glycol, and polyethylene glycol dimethyl ether, for example, can be cited as polyalcohol and polyalcohol derivatives that can be utilized according to the present invention.

Nonionic and cationic surfactants to which ethylene oxide has been added are preferable as surfactants that can be utilized according to the present invention. This is because there is a risk that anionic surfactants may cause a problem in terms of compatibility with a fiber decomposing agent and foaming.

Ether type nonionic surfactants, such as polyoxyethylene alkyl ether, ether ester type nonionic surfactants, such as polyoxyethylene glycerin fatty acid ester, ester type nonionic surfactants, such as polyethylene glycol fatty acid ester, and the like can be cited as nonionic surfactants to which ethylene oxide has been added.

In addition, aliphatic amine salts, aliphatic quaternary ammonium salts and the like to which ethylene oxide has been added can be cited as the cationic surfactants to which ethylene oxide has been added.

In particular, propylene glycol is more preferable, considering that it is excellent in terms of safety. In addition, aliphatic quaternary ammonium salts to which ethylene oxide has been added is more preferable, considering that its stability in alkaline solution is high.

In addition, in the case of application to an ink jet, it is preferable for the surfactants to have a low viscosity, where the number average molecular weight is not greater than 5000. In the case where the number average molecular weight is 5000 or higher, the viscosity of the ink increases, and stability in the discharge of ink tends to be low.

The raised fabric that is utilized according to the present invention is a woven fabric, a knit fabric, a non-woven fabric, a flocked fabric or the like which has raised pile on the surface thereof. Concretely speaking, pile textiles, such as moquette, velvet and velveteen, plush textiles obtained as a result of a gigging process, and conventionally utilized raised fabrics, such as Paul Tricot and Double Russell, can be cited. Concerning the form of the raised pile, loop forms and straight forms in accordance with broad classification can be cited, and straight forms are preferable, considering that they allow dense arrangement of raised piles.

Fibers that form the raised fabric that is utilized according to the present invention can be freely selected from natural fibers, regenerated fibers, semi-synthesized fibers and synthesized fibers, and these may be used by themselves or mixed. Synthesized fibers, such as polyester fibers, polyamide fibers and polyacrylic fibers are preferable, considering that uniform cross sections at the ends can be secured in accordance with their manufacturing method and the thickness of each fiber can be adjusted. Furthermore, polyester fibers are preferable, considering that they have durability, such as durability against light when used as an interior material for a car.

It is preferable for the thickness of each fiber of the raised pile which are utilized according to the present invention to be in a diameter range from 2 μm to 20 μm. In the case where the thickness of each fiber exceeds 20 μm, the working efficiency of the fiber decomposing agent becomes low, and thus, a sufficient uneven expression cannot be achieved, and curved and inclined surfaces which smoothly continue tend not to be formed, while in the case where the thickness is less than 2 μm, the fiber decomposing agent works too strongly and meticulous control of the form of the unevenness (such as depth and width) tends to become difficult. More preferably, the diameter range of the thickness is from 5 μm to 10 μm.

Furthermore, it is preferable for the length of the raised pile (length of the pile) which are utilized according to the present invention to be in a length range from 0.5 mm to 3.0 mm, considering that such raised pile do not stay bent and have strong recovery due to elasticity when bent. It is more preferable for the length range to be from 1.0 mm to 2.5 mm. In the case where the length of the raised pile exceeds 3 mm, the raised pile does not recover when bent, and the uneven pattern formed on the surface tends to disappear, while in the case where the length of the raised pile is shorter than 0.5 mm, a sufficient depth to obtain a shade effect in the unevenness tends not to be obtained. Here, this length of the raised pile is the length between the surface on the side where the base has the raised pile and the end of the raised pile.

A fabric having a density of raised pile (density of pile) of 200/mm² to 4000/mm² is generally utilized as a raised fabric of the present invention, and a high density is preferable, in order to form an uneven pattern that has smooth curved surfaces, particularly having a large curvature, and steeply inclined surfaces having a large angle. An extremely high density prevents sufficient penetration of the fiber decomposing agent into the fiber, and as a result, a deep uneven pattern tends to be difficult to express. Accordingly, it is preferable for the density of the pile to be in a range from 400/mm² to 1000/mm², taking the above described thickness of each fiber into consideration.

Hereinafter, the present invention is explained in detail based on Examples and Comparative Examples, but not limited thereto. In Examples and Comparative Examples, “part(s)” represent “part(s) by weight”.

### EXAMPLE 1

Raised fabric (Double Russell) of polyester fibers of which the thickness of each fiber was 10 μm having a pile density of 700/mm² and a pile length of 2 mm was utilized as a fabric where an uneven pattern is formed.

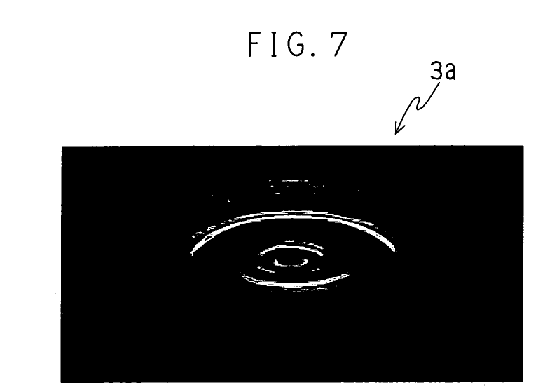

Digital image data for developing a pattern of which motif was ripple 3a shown in FIG. 7 was utilized for the uneven pattern.

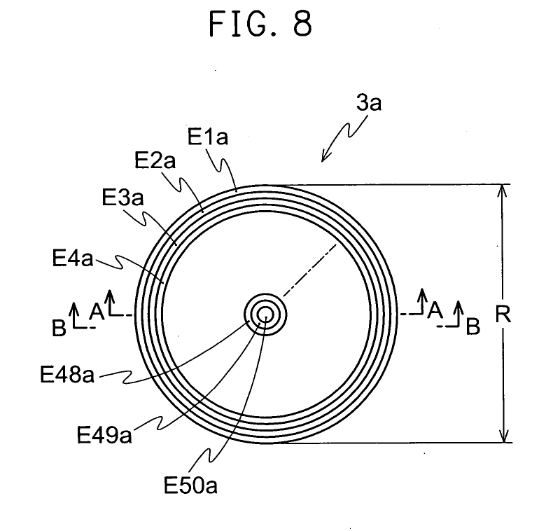

FIG. 8 is a diagram illustrating digital data of motif 3a where diameter R of the ripple is 40 mm. The motif was divided into areas numbered 1 to 50 (E1a to E50a with intervals of 0.4 mm), and a fiber decomposing agent (of which the viscosity is 2.0 cps) was added to each area in the following printing conditions by means of an ink jet system. Here, the viscosity of the ink was measured at 25° C. using a BL type viscometer (BL rotor, 60 rpm) made by Tokyo Keiki Co. Ltd.

The amount of fiber decomposing agent that was added was controlled by a computer for each area, as shown in Table 1, in order to adjust the depth of unevenness in each area. That is to say, the amount of fiber decomposing agent that is attached to each microscopic area was discontinuously changed in steps, and thereby, an uneven pattern forming a smooth curved surface was obtained.

<Composition of Fiber Decomposing Agent>

| | |
|---|---|
| Guanidine carbonate | 25 parts |
| Water | 73 parts |
| Propylene glycol | 2 parts |

<Conditions for ink jet printing>

Printing device: On-demand system serial scanning type ink jet printing device

Nozzle diameter: 50 μm

Driving voltage: 100 V

Frequency: 5 kHz

Resolution: 360 dpi

TABLE 1

| | Area No. | | | | | | | | | |
|---|---|---|---|---|---|---|---|---|---|---|
| | No. 1 | No. 2 | No. 3 | No. 4 | No. 5 | No. 6 | No. 7 | No. 8 | No. 9 | No. 10 |
| Amount of fiber | 30 | 28 | 22 | 18 | 14 | 10 | 6 | 4 | 2 | 0 |
| decomposing agent | | | | | | | | | | |
| (g/m²) | | | | | | | | | | |
| | Area No. | | | | | | | | | |
| | No. 11 | No. 12 | No. 13 | No. 14 | No. 15 | No. 16 | No. 17 | No. 18 | No. 19 | No. 20 |
| Amount of fiber | 2 | 4 | 6 | 8 | 10 | 12 | 16 | 20 | 22 | 24 |
| decomposing agent | | | | | | | | | | |
| (g/m²) | | | | | | | | | | |
| | Area No. | | | | | | | | | |
| | No. 21 | No. 22 | No. 23 | No. 24 | No. 25 | No. 26 | No. 27 | No. 28 | No. 29 | No. 30 |
| Amount of fiber | 26 | 27 | 28 | 29 | 30 | 29 | 28 | 27 | 26 | 24 |
| decomposing agent | | | | | | | | | | |
| (g/m²) | | | | | | | | | | |
| | Area No. | | | | | | | | | |
| | No. 31 | No. 32 | No. 33 | No. 34 | No. 35 | No. 36 | No. 37 | No. 38 | No. 39 | No. 40 |
| Amount of fiber | 22 | 20 | 16 | 12 | 10 | 8 | 6 | 4 | 2 | 0 |
| decomposing agent | | | | | | | | | | |
| (g/m²) | | | | | | | | | | |
| | Area No. | | | | | | | | | |
| | No. 41 | No. 42 | No. 43 | No. 44 | No. 45 | No. 46 | No. 47 | No. 48 | No. 49 | No. 50 |
| Amount of fiber | 0 | 2 | 4 | 6 | 8 | 10 | 14 | 18 | 22 | 26 |
| decomposing agent | | | | | | | | | | |
| (g/m²) | | | | | | | | | | |

A wet thermal treatment was carried out at 175° C. for 10 minutes on a fabric on which a pattern is printed, after it had been dried. After that, the fabric was cleaned and dried, and a brushing process was carried out.

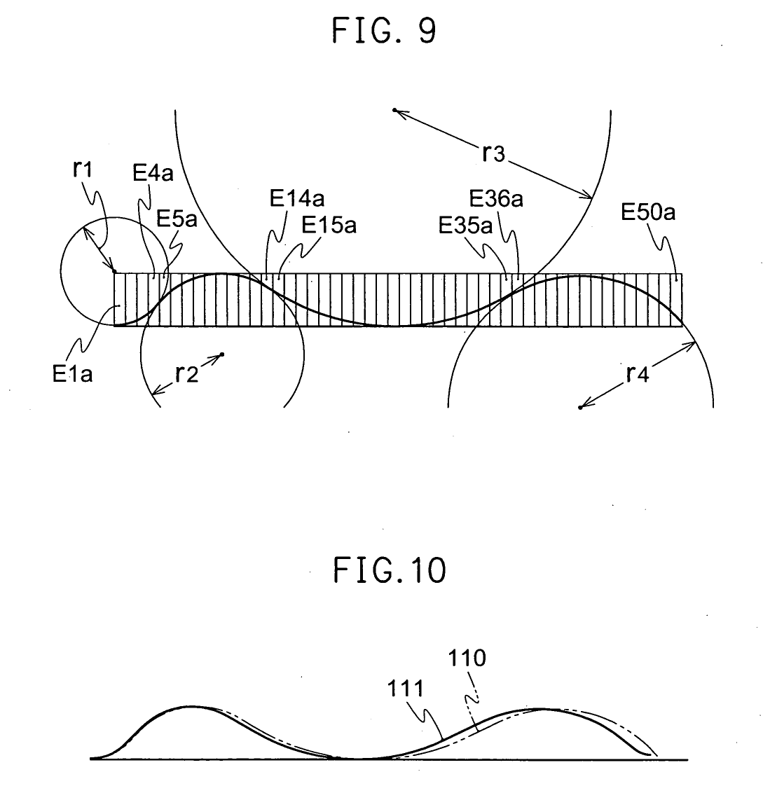

The upper side of the cross section (A-A cross section of FIG. 8) of the fabric having a three-dimensional pattern that has been obtained as described above becomes as that in FIG. 9, and the upper side of the cross section formed a curve. Curvature radii r1, r2, r3 and r4 of the respective curves became 3 mm in area numbers 1 to 4 (E1 to E4), 4 mm in area numbers 5 to 14 (E5 to E14), 8 mm in area numbers 15 to 35 (E15 to E35) and 5 mm in area numbers 36 to 50 (E36 to E50), which were different from one another. Here, FIG. 9 schematically shows a portion of the cross section from area number 1 to area number 50, that is to say, between a circular peripheral portion and the center portion of a circle from the cross section along A-A.

Here, the curvature radii were found in the following manner. A photograph of the cross section along A-A was taken by a scanning electron microscope, and a polygonal line was created by connecting the center of the upper area formed raised pile having the same height to the center of the adjacent upper area with lines. Then, a circle that circumscribes this polygonal line was found, and the curvature radius of this circle was found.

In addition, FIG. 10 shows the upper side of the cross section along B-B that is 0.3 mm away from the cross section along A-A. Here, in FIG. 10, upper side 111 of the cross section along B-B is shown in full line, and the upper side of the cross section along A-A is shown in broken line 110, for the purpose of comparison. As can be seen by comparing these, the cross sectional areas and the cross sectional forms of these were different from each other.

This raised fabric having a three-dimensional pattern expresses a natural uneven pattern like an actual ripple, and shades can be formed as viewed in any direction under natural light, and the appearance is enhanced.

### EXAMPLE 2

A raised fabric (fully cut plush knit fabric) of polyester fibers of which the thickness of each fiber is 10 μm having a pile density of 700/mm² and a pile length of 2 mm was utilized as a fabric where an uneven pattern is formed.

Digital data as shown in FIG. 11 was utilized to obtain an uneven pattern of which the motif was willow 3b. Here, FIG. 11 illustrates a portion of the digital data, and it actually continues in the longitudinal and lateral directions.

FIG. 11 shows divided areas numbered 1 to 10 (E1b to E50b with intervals of 0.3 mm to 0.5 mm), and thus, a raised fabric having a three-dimensional pattern was obtained in the same manner as in Example 1, except that the amount of added fiber decomposing agent was changed in order to adjust the depth of the unevenness, as shown in Table 2.

TABLE 2

| | Area No. | | | | | | | | | |
|---|---|---|---|---|---|---|---|---|---|---|
| | No. 1 | No. 2 | No. 3 | No. 4 | No. 5 | No. 6 | No. 7 | No. 8 | No. 9 | No. 10 |
| Amount of fiber | 6 | 14 | 22 | 30 | 26 | 22 | 18 | 14 | 10 | 6 |
| decomposing agent | | | | | | | | | | |
| (g/m²) | | | | | | | | | | |

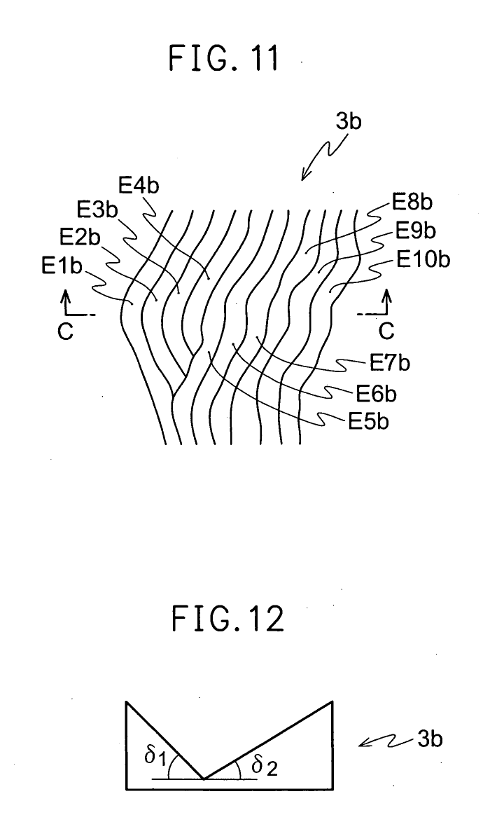

The upper side of the cross section (the intervals between the areas in the cross section along C-C of FIG. 11 are 0.4 mm) of the obtained fabric having a three-dimensional pattern became like that in FIG. 11, and the upper side of the cross section formed lines of which the inclination angles of the recesses and protrusions on the right and on the left were symmetrical. As for the angles of the respective lines relative to the bottom, δ1 was 60°, and δ2 was 45°. Here, FIG. 12 shows only the portions of areas numbered 1 to 10 of the fabric.

In addition, the cross section along C-C was compared with the cross section 0.3 mm away from it, in the same manner as in Example 1, and the cross sectional areas and the cross sectional forms of these were found to be different from each other.

A random uneven willow pattern is expressed on this fabric having a three-dimensional pattern, like a fabric on which actual wrinkle processing has been carried out, and shades can be formed as viewed from any direction under natural light, and the appearance is enhanced.

### COMPARATIVE EXAMPLE 1

A raised fabric (Double Russell) of polyester fibers of which the thickness of each fiber was 10 μm having a pile density of 700/mm² and a pile length of 2 mm was utilized as a fabric where an uneven pattern is formed.

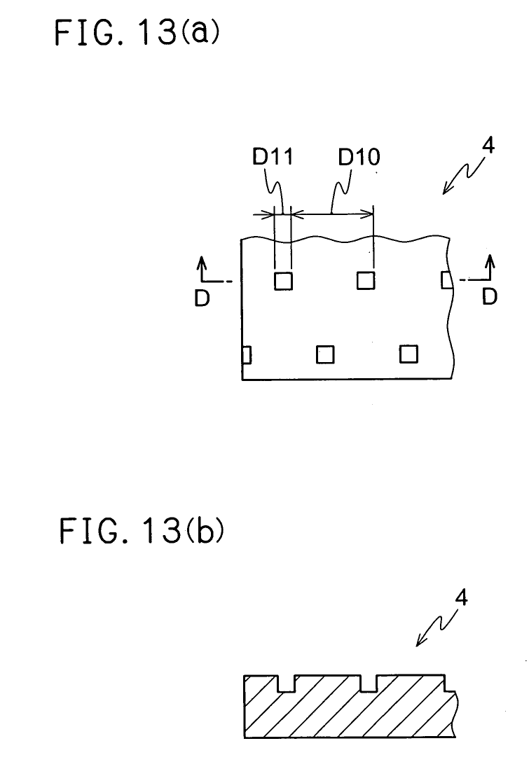

An emboss process of a square of 4 mm, as shown in FIG. 13(a), was carried out as uneven patterning so as to obtain a fabric having a three-dimensional pattern 4. As described above, the recesses were squares of 4 mm (D11) and the intervals between the recesses (D10) were 20 mm.

The pattern of the obtained fabric having a three-dimensional pattern was sketched perpendicularly to the bottom, as shown in the cross section along D-D of FIG. 13(b).

In addition, the areas and the forms of the cross sections 0.3 mm away from the cross section along D-D were the same as those of the cross section D-D, as if the cross section along D-D was slid to the left and to the right.

An uneven pattern disappears in this fabric having a three-dimensional pattern, as viewed vertically from the top under natural light, and thus, shades could not be created from any direction, and the appearance was not enhanced.

### COMPARATIVE EXAMPLE 2

A raised fabric (double Russell) of polyester fibers of which the thickness of each fiber was 10 μm having a pile density of 700/mm² and a pile length of 2 mm was utilized as a fabric where an uneven pattern is formed.

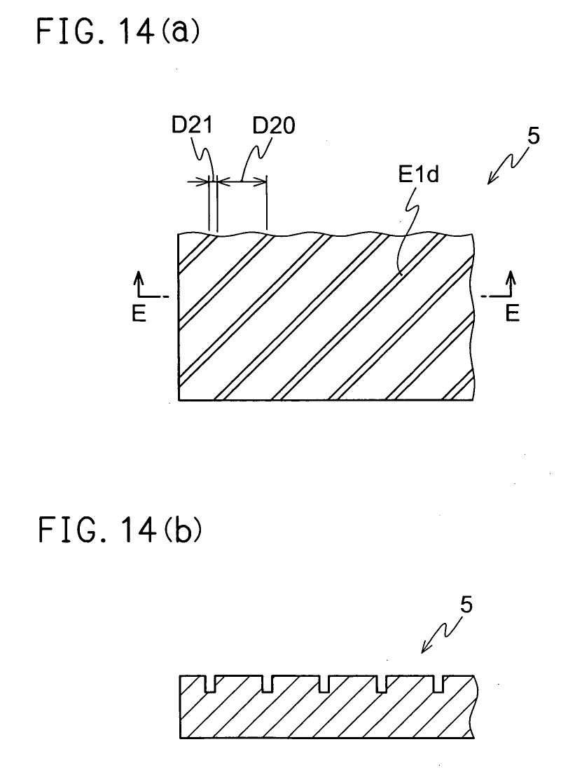

Digital data of a line pattern with a width of 2 mm, as shown in FIG. 14(a), was utilized as the uneven pattern. As described above, the width (D21) of the line pattern was 2 mm, and the intervals (D20) of the line pattern were 10 mm.

A fiber decomposing agent (of which the viscosity at 25° C. is 2.5 cps) was prepared as below, and a raised fabric having a three-dimensional pattern 5 was obtained in the same manner as in Example 1, except that the amount added to area E1d was 50 g/m².

<Composition of Fiber Decomposing Agent>

| | |
|---|---|
| Sodium hydroxide | 20 parts |
| Water | 78 parts |
| Propylene glycol | 2 parts |

The pattern of the obtained fabric having a three-dimensional pattern was sketched perpendicularly to the bottom, as shown in the cross section along E-E of FIG. 14.

In addition, the areas and the forms of the cross sections 0.3 mm away from the cross section along E-E were the same as those of the cross section along E-E, as if the cross section E-E was slid to the right and to the left.

An uneven pattern disappears in this fabric having a three-dimensional pattern, as viewed vertically from the top under natural light, and thus, shades could not be created from any direction, and the appearance was not enhanced.

1. A raised fabric having a three-dimensional pattern, of which the cross sectional areas in plurality of cross sections parallel to each other are different from each other.

2. The raised fabric having a three-dimensional pattern of claim 1, of which the cross sectional forms in plurality of cross sections parallel to each other are also different from each other.

3. The raised fabric having a three-dimensional pattern of claim 1, wherein the upper sides of said cross sections are formed of continuous curves having curvature radii of 1 mm to 10 mm.

4. The raised fabric having a three-dimensional pattern of claim 3, wherein the upper sides of said cross sections are formed of continuous curves having different curvature radii.

5. The raised fabric having a three-dimensional pattern of claim 1, wherein the upper sides of said cross sections are formed of continuous lines having angles from 20° to 90° relative to the bottom of the cross sections.

6. The raised fabric having a three-dimensional pattern of claim 5, wherein the upper sides of said cross sections are formed of continuous lines having different angles relative to the bottom of the cross sections.

7. The raised fabric having a three-dimensional pattern of claim 1, wherein the distances between said cross sections are not greater than 0.5 mm.

8. The raised fabric having a three-dimensional pattern of claim 1, which is obtained by discontinuously changing an amount of a fiber decomposing agent that is attached to each microscopic area using an ink jet system.
